(19) United States
(12) Patent Application Publication
(10) Pub. No.: US 2012/0157025 A1
(43) Pub. Date: Jun. 21, 2012

(54) METHOD AND APPARATUS FOR SCANNING CHANNEL IN BROADCAST RECEIVER

(75) Inventors: Jin-Woo SEO, Seoul (KR); Dong-Cheol BAEK, Seoul (KR); Joon-Woo KIM, Gyeonggi-do (KR)

(73) Assignee: SAMSUNG ELECTRONICS CO., LTD., Gyeonggi-Do (KR)

(21) Appl. No.: 13/328,276

(22) Filed: Dec. 16, 2011

(30) Foreign Application Priority Data
Dec. 17, 2010 (KR) 10-2010-0129799

(51) Int. Cl. H04B 1/18

(52) U.S. Cl. 455/161.1

(57) ABSTRACT

A method for scanning a channel in a broadcast receiver is provided. In the method, a broadcast area corresponding to a current position is derived from a database (DB). When a valid channel list for the derived broadcast area exists in the DB is determined, broadcasting using the information of the valid channel list. However, when the valid channel list for the derived broadcast area does not exist, a search for a channel for the derived broadcast area is initiated.

### CLAIM OF PRIORITY

This application claims the benefit of priority under 35 U.S.C. §119(a) from Korean patent application filed in the Korean Intellectual Property Office on Dec. 17, 2010 and assigned Serial No. 10-2010-0129799, the entire disclosure of which is hereby incorporated by reference.

### BACKGROUND OF THE INVENTION

1. Field of the Invention

The present invention relates the field of wireless communications. More particularly, to a method and an apparatus for searching for a channel depending on movement of a broadcast receiver.

2. Description of the Related Art

First generation broadcast services were composed of analog transmissions, which are limited to voice communications. Digital broadcast service have quickly been distributed, wherein the digital broadcast service provide various data to a user as well as improved image/voice compared to the existing analog broadcast.

In an area that does not provide the digital broadcast service, the analog broadcast service is still provided. With consideration of this situation, an analog/digital broadcast receiver that may use both the analog and the digital broadcast services has introduced. This combination analog/digital broadcast receiver may be a television (TV), a mobile phone, a set top-box, etc.

Generally, the analog/digital broadcast receiver searches for an analog broadcast channel and a digital broadcast channel over all frequencies, within their respective frequency ranges. At this point, in the case where a relevant area provides only one of the two broadcast services, it is inefficient to search for a channel of a not-provided broadcast service. In addition, a list of channels searched in this manner may not be useful in a different area, and the receiver searches for a channel in the different area again.

### SUMMARY OF THE INVENTION

An aspect of the present invention is to address at least the above-mentioned problems and/or disadvantages and to provide at least the advantages described below. Accordingly, an aspect of the present invention is to provide a method and an apparatus for scanning a channel with consideration of a broadcast service type provided depending on an area.

Another aspect of the present invention is to provide a method and an apparatus for automatically searching for a channel when a broadcast area changes.

Still another aspect of the present invention is to provide a method and an apparatus for avoiding searching for a channel unnecessarily by obtaining a list of channels of a relevant area.

Other aspects, advantages and salient features of the invention will become apparent to those skilled in the art from the following detailed description, which, taken in conjunction with the annexed drawings, discloses exemplary embodiments of the invention.

In accordance with an exemplary embodiment of the present invention, a method for scanning a channel in a broadcast receiver is provided. The method includes determining a current position, and deriving a broadcast area corresponding to the current position from a database (DB), determining whether a valid channel list for the derived broadcast area exists in the DB, and starting a search for a channel for the derived broadcast area when the valid channel list for the derived broadcast area does not exist.

In accordance with another exemplary embodiment of the present invention, an apparatus for scanning a channel in a broadcast receiver is provided. The apparatus includes a memory for storing broadcast information, a position information unit for outputting position information, a scan setting unit for deriving a relevant broadcast area from the memory based on the position information output from the position information unit, and when a valid channel list for the derived broadcast area does not exist in the memory, initiating a channel search for the derived broadcast area, and a synchronizer for searching for a channel under control of the scan setting unit.

In accordance with yet another exemplary embodiment of the present invention, an apparatus for scanning a channel in a broadcast receiver is provided. The apparatus includes a memory for storing broadcast information, a position information unit for outputting position information, a scan setting unit for determining a current position from the position information output from the position information unit, and when it is determined that the current position deviates from an existing broadcast area in the memory, initiating a channel search for a changed broadcast area, and a synchronizer for searching for a channel under control of the scan setting unit.

In accordance with still another exemplary embodiment of the present invention, a method for helping channel search of a broadcast receiver in a network server is provided. The method includes detecting a position of the broadcast receiver, deriving a broadcast area to which the detected position belongs from a database (DB), deriving broadcast information regarding the derived broadcast area from the DB, and transmitting the derived broadcast information to the broadcast receiver.

### BRIEF DESCRIPTION OF THE DRAWINGS

The above and other aspects, features and advantages of certain exemplary embodiments of the present invention will be more apparent from the following description taken in conjunction with the accompanying drawings in which:

FIG. 1 is a block diagram illustrating an analog/digital broadcast receiver according to an exemplary embodiment of the present invention;

FIGS. 2A to 2B are a flowchart illustrating a procedure for automatically searching for a channel when a broadcast area changes in an analog/digital broadcast receiver according to an exemplary embodiment of the present invention;

FIG. 3 is a flowchart illustrating a method for searching for a channel at a current position in an analog/digital broadcast receiver according to an exemplary embodiment of the present invention;

FIG. 4 is a flowchart illustrating a method for searching for a channel depending on change of a broadcast area in an analog/digital broadcast receiver according to an exemplary embodiment of the present invention; and

FIGS. 5A to 5B are a flowchart illustrating a procedure for providing broadcast information at a network server to an analog/digital broadcast receiver according to an exemplary embodiment of the present invention.

Throughout the drawings, like reference numerals will be understood to refer to like parts, components and structures.

### DETAILED DESCRIPTION

The following description, with reference to the accompanying drawings, is provided to assist a person of ordinary skill in the art with a comprehensive understanding of exemplary embodiments of the invention. The description includes various specific details to assist in that understanding but these details are to be regarded as merely exemplary. Accordingly, those of ordinary skill in the art will recognize that various changes and modifications of the exemplary embodiments described herein can be made without departing from the spirit of the invention and the scope of the appended claims. Also, descriptions of well-known functions and constructions may be omitted for clarity and simplicity so as not to obscure appreciation of the present invention by a person of ordinary skill with such well-known functions and constructions.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purposes only and not for the purpose of limiting the invention as defined by the appended claims.

It is to be understood that the singular forms “a”, “an”, and “the” include plural references unless the context clearly dictates otherwise. Thus, for example, reference to “a component surface” typically includes reference to one or more of such surfaces.

By the term “substantially” typically means that the recited characteristic, parameter, or value need not be achieved exactly, but that deviations or variations, including for example, tolerances, measurement error, measurement accuracy limitations and other factors known to those skilled in the art, and may occur in amounts that do not preclude the effect the characteristic was intended to provide.

Exemplary embodiments of the present invention provide an apparatus and a method for scanning a channel received by a broadcast receiver. More particularly, exemplary embodiments of the present invention provide a method and an apparatus for efficiently searching for a channel depending on position movement of a broadcast receiver. A broadcast receiver according to an exemplary embodiment of the present invention may receive an analog broadcast and a digital broadcast. For example, the analog/digital broadcast receiver may be a TV, a set top-box, a cellular phone, etc.

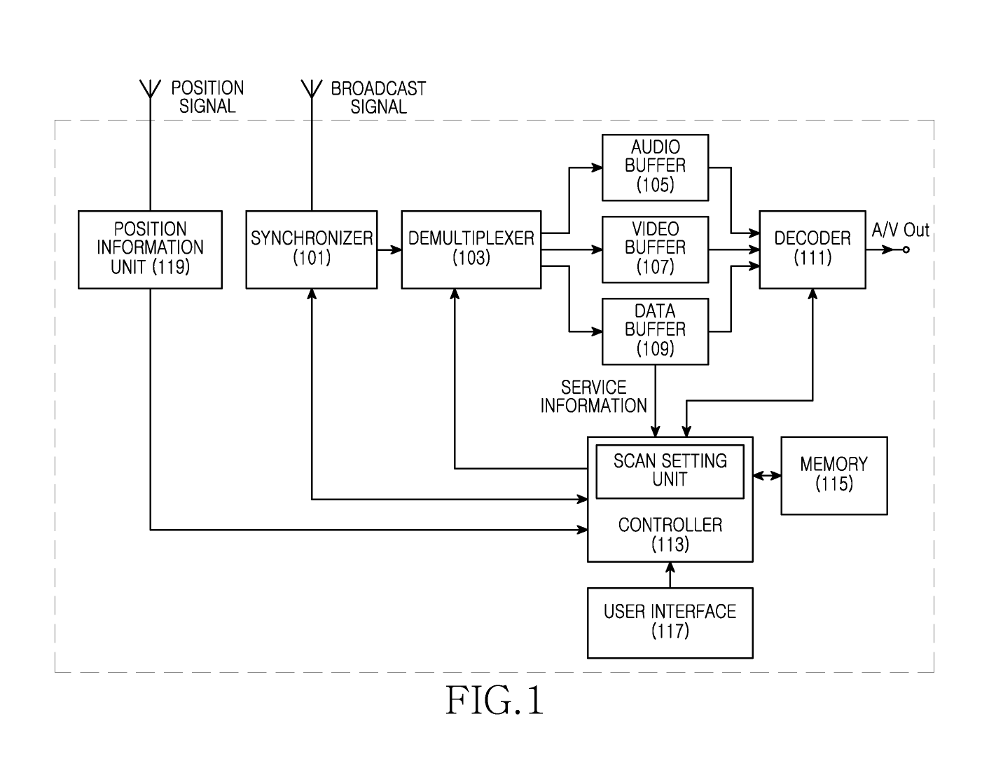

FIG. 1 is a block diagram illustrating an exemplary analog/digital broadcast receiver according to an exemplary embodiment of the present invention.

Referring to FIG. 1, the analog/digital broadcast receiver includes a synchronizer 101 for receiving a broadcast signal, a demultiplexer 103 for separating a transmission stream of a broadcast program received via the synchronizer 101 into audio, video. and data, an audio buffer 105 for temporarily storing audio output from the demultiplexer 103, a video buffer 107 for temporarily storing video output from the demultiplexer 103, a data buffer for temporarily storing data output from the demultiplexer 103, a decoder 111 for decoding signals of the buffers 105, 107, and 109, and a memory 115 for storing various data required for an operation of the analog/digital broadcast receiver and programs.

Furthermore, the analog/digital broadcast receiver according to an exemplary embodiment of the present invention includes a position information unit 119 for determining a position. For example, the position information unit 119 may output position information via a Global Positioning System (GPS). In case of a cellular phone, the position information unit 119 may detect a position via a service cell identifier (ID) of a base station. In addition, in case of a cellular phone, the position information unit 119 may receive position information from a network server.

The memory 115 stores an operation program for performing a channel search operation and various data required during an operation of the operational program in the analog/digital broadcast receiver. For example, the memory 115 stores information regarding a position range of each broadcast area. For example, to which broadcast area the current position belongs may be determined afterward. In addition, the memory 115 stores information (Table 1) regarding a broadcast service type provided by each broadcast area. The information regarding the position range of the broadcast area and the broadcast service type may be updated via wired communication or wireless communication.

Furthermore, the memory 115 stores a channel list (Table 2) generated after channel search. The channel list stores channel information provided by a broadcast service provider. The channel list is stored for each broadcast area, and an invalid channel list is updated afterward. Here, the invalid channel list denotes a channel list generated long before and which is not a recent list. For example, a channel list whose channels were searched for one month before or more may be regarded as an invalid channel list. That is, an active list may be moved to an invalid channel list after a predetermined period of time.

TABLE 1

| The Broadcast area | The Broadcast service type |
|---|---|
| Seoul | An analog broadcast service and digital broadcast |
| | service |
| Daejeon | An analog broadcast service |
| — | — |

TABLE 2

| The Digital broadcast channels | Name | Frequency | Contents |
|---|---|---|---|
| CH1 | KBS News | f1 | News |
| CH2 | KBS Sports | f2 | Sports |
| — | — | — | — |

The synchronizer 101 synchronizes a broadcast channel selected by a user during digital broadcasting. For this purpose, in the case where a user selects an unspecific broadcast channel via a user interface 117, a controller 113 reads information corresponding to the selected broadcast channel from the memory 115 and provides the same to the synchronizer 101.

In addition, the controller 113 reads Service Information (SI) temporarily stored in the data buffer and uses it as reference information for broadcast signal processing and various controls.

The analog/digital broadcast receiver according to an exemplary embodiment of the present invention includes the controller 113 for performing various controls required by the analog/digital broadcast receiver, such as reception of an analog/digital broadcast program via the synchronizer 101, recording of an arbitrary broadcast program, reproduction of a broadcast program stored in a hard disk (not shown), etc. The controller 113 includes a scan setting unit for controlling a channel search operation. The scan setting unit determines a relevant broadcast area and a broadcast service type from the memory 115 based on position information provided by the position information unit 119, and searches for a channel regarding the broadcast service type (for example, an analog broadcast service or a digital broadcast service). For example, when a digital broadcast service area is determined, the scan setting unit controls the search process to search for only a digital broadcast channel. When an analog broadcast service is determined, the scan setting unit controls a search process to search for only an analog broadcast channel. In addition, the scan setting unit determines whether a broadcast area changes based on the position information received from the position information unit 119. When the broadcast area changes, in the case where a valid channel list for the changed broadcast area does not exist, the scan setting unit controls a process to automatically search for a channel (based on the service type of the changed area).

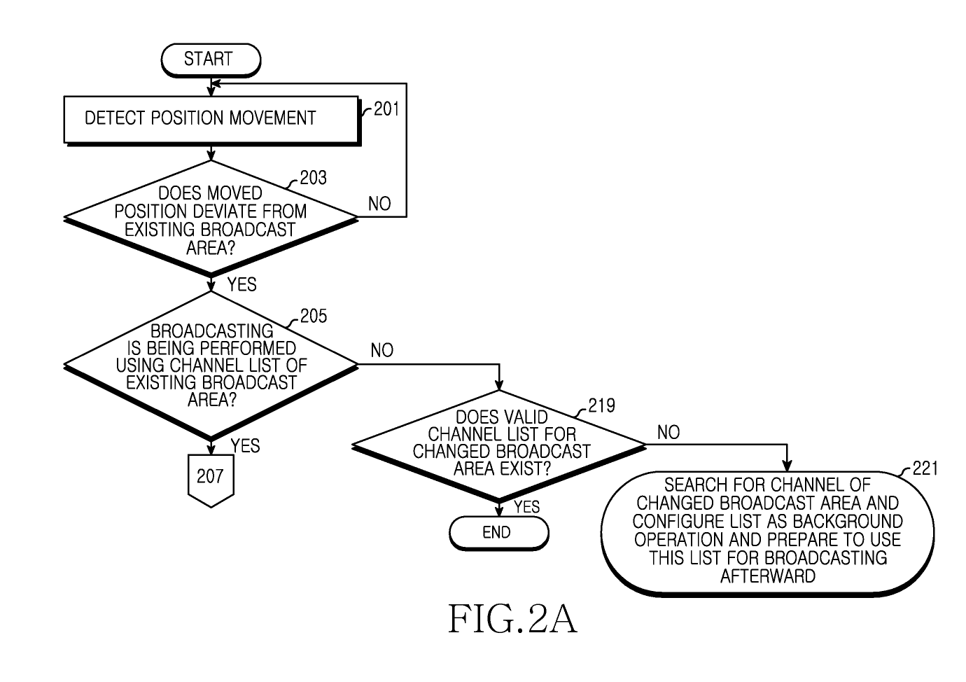

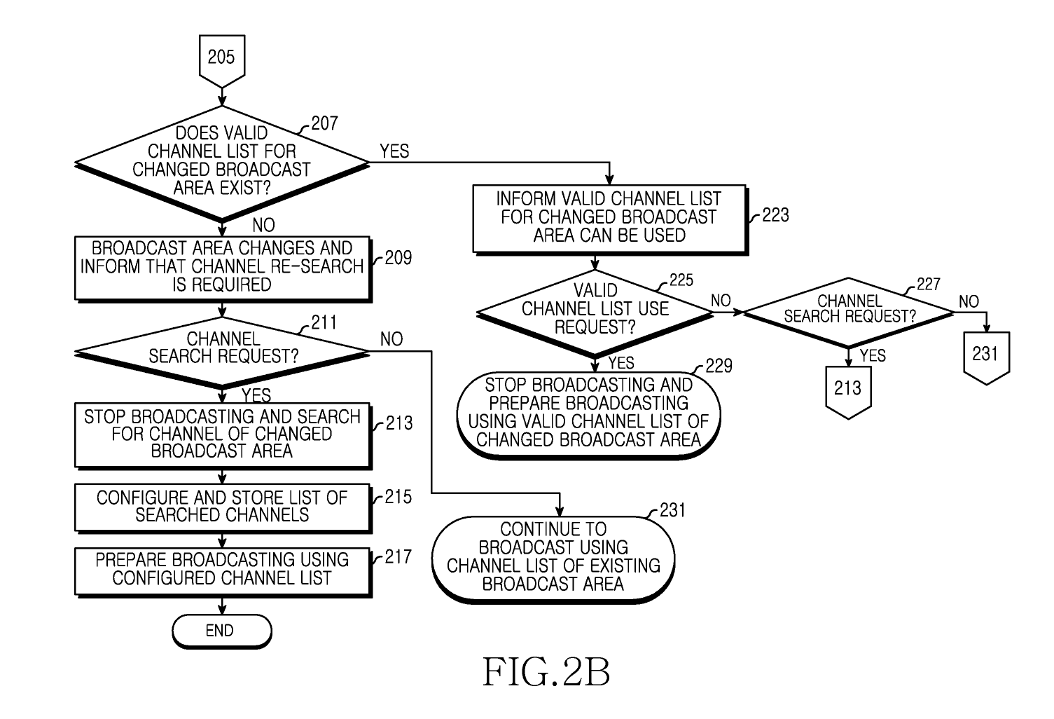

FIGS. 2A to 2B are a flowchart illustrating a procedure for automatically searching for a channel when a broadcast area changes in an analog/digital broadcast receiver according to an exemplary embodiment of the present invention.

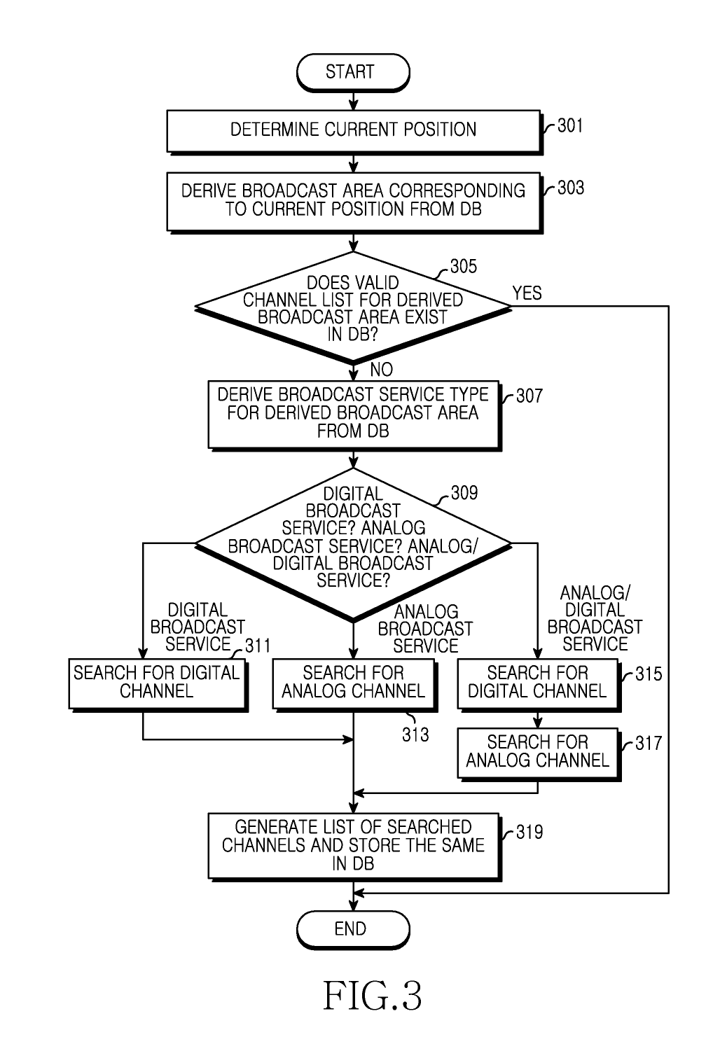

Referring to FIGS. 2A and 2B, the broadcast receiver detects position movement in step 201. A method for detecting position movement at the broadcast receiver is described with reference to FIG. 3.

The broadcast receiver determines whether the moved position deviates from an existing broadcast area in step 203. For reference, the broadcast receiver stores information regarding a position range of each broadcast area and may update this afterward.

When the moved position deviates from the existing broadcast area, the broadcast receiver determines whether broadcasting is performed using a channel list of the existing broadcast area in step 205.

When broadcasting is performed using the channel list of the existing broadcast area, the broadcast receiver proceeds to step 207 to determine whether a valid channel list for the changed broadcast area exists. The valid channel list includes the latest channel information. For example, a channel list generated within less than one month may be regarded as a valid channel list. When the valid channel list for the changed broadcast area does not exist, the broadcast receiver proceeds to step 209 to inform that the broadcast area has changed and channel re-search is required. Next, the broadcast receiver determines whether channel search is requested in step 211.

When the channel search is not requested, the broadcast receiver continues to broadcast using the channel list of the existing broadcast area in step 231.

However, when the channel search is requested at step 211, the broadcast receiver stops broadcasting and searches for a channel of the changed broadcast area in step 213. After that, the broadcast receiver configures a list of searched channels and prepares broadcasting using this configured channel list in steps 215 to 217.

When the broadcast receiver is not broadcasting using the channel list of the existing broadcast area in step 205, the broadcast receiver proceeds to step 219 determine whether a valid channel list for the changed broadcast area exists. When a valid channel list for the changed broadcast area does not exist, the broadcast receiver proceeds to step 221 to perform as a background operation, search for a channel of the changed broadcast area, configure the search results as a list, and prepare this list so that the list may be used for broadcasting afterward.

However, when the valid channel list for the changed broadcast area exists, the broadcast receiver ends the present procedure.

Furthermore, when the valid channel list for the changed broadcast area exists in step 207, the broadcast receiver proceeds to step 223 to inform that the valid channel list for the changed broadcast area may be used. When use of the valid channel list for the changed broadcast area is requested in step 225, the broadcast receiver proceeds to step 229 to stop broadcasting and prepare broadcasting using the valid channel list for the changed broadcast area.

In contrast, when use of the valid channel list for the changed broadcast area is not requested in step 225, the broadcast receiver proceeds to step 227 to determine whether a channel search request occurs. When the channel search request occurs in step 227, the broadcast receiver performs processes in steps 213-217.

However, when the channel search request does not occur in step 227, the broadcast receiver proceeds to step 231 to continue broadcasting using the channel list of the existing broadcast area.

FIG. 3 is a flowchart illustrating a method for searching for a channel at a current position in an analog/digital broadcast receiver according to an exemplary embodiment of the present invention.

Referring to FIG. 3, the broadcast receiver determines a current position in step 301. The broadcast receiver determines the current position by calculating the position by itself or by receiving a calculated position from an external device. For example, in the case where the broadcast receiver is a cellular phone where a GPS is possible, the broadcast receiver may determine the position using the following method. Firstly, the cellular phone may determine the position of itself through the GPS without using a base station or a different device. That is, the cellular phone may calculate the position by directly receiving a plurality of satellite signals. Secondly, the cellular phone requests GPS satellite information from a server and receives the same, determines a relevant GPS satellite using the received GPS satellite information via the GPS, and calculates the position of itself. The server periodically transmits updated GPS satellite information to the cellular phone. Thirdly, the cellular phone may determine the position via a network. A network server may calculate the position and provide the same to the cellular phone.

The method for determining the current position at the broadcast receiver is not limited thereto but the cellular phone may determine the position via a service cell ID of a base station.

Next, the broadcast receiver derives a broadcast area corresponding to the determined current position from a database (DB) in step 303.

The broadcast receiver determines whether a valid channel list for the derived broadcast area exists in the DB in step 305. The valid channel list includes the latest channel information. For example, a channel list generated within less than one month may be regarded as the valid channel list. When the valid channel list for the derived broadcast area exists in the DB, the broadcast receiver determines that channel search is not required and ends the present procedure.

However, when the valid channel list for the derived broadcast area does not exist in the DB, the broadcast receiver proceeds to step 307 to derive a broadcast service type for the derived broadcast area from the DB and perform a channel search procedure subsequent to step 309.

The broadcast receiver determines a broadcast service derived from the DB in step 309. When a digital broadcast service is determined in step 309, the broadcast receiver searches for a digital channel in step 311. In addition, when an analog broadcast service is determined in step 309, the broadcast receiver searches for an analog channel in step 313. Furthermore, when both an analog and a digital broadcast service is determined in step 309, the broadcast receiver searches for a digital channel in step 315 and then searches for an analog channel in step 317.

The broadcast receiver generates a list of searched channels and stores the same in the DB in step 319.

That is, the broadcast receiver according to an exemplary embodiment of the present invention determines the current position and then determines a broadcast service type provided at the determined position from the DB. Therefore, the broadcast receiver may avoid searching for a channel of a broadcast service that is not provided at the current position.

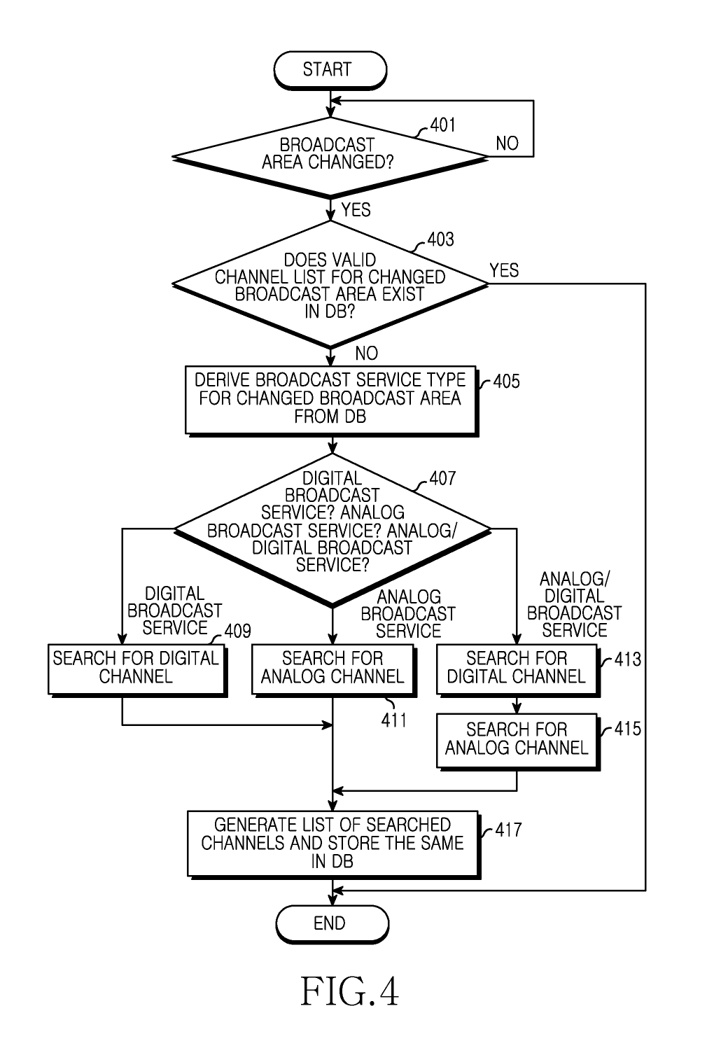

FIG. 4 is a flowchart illustrating a method for searching for a channel depending on change of a broadcast area in an analog/digital broadcast receiver according to an exemplary embodiment of the present invention.

Referring to FIG. 4, the broadcast receiver determines whether the position of the broadcast receiver has changed to a new a broadcast area h in step 401.

When the position of the broadcast receiver has changed to a new broadcast area, the broadcast receiver determines whether a valid channel list for the changed broadcast area exists in a DB in step 403. The valid channel list includes the latest channel information. For example, a channel list generated within the last month may be regarded as the valid channel list. When the valid channel list for the changed broadcast area exists, the broadcast receiver determines that a channel search is not required and ends the present procedure.

However, when the valid channel list for the changed broadcast area does not exist, the broadcast receiver proceeds to step 405 to determine a broadcast service type for the changed broadcast area from the DB, and perform a channel search procedure subsequent to step 407.

The broadcast receiver determines a type of the broadcast service based on information regarding the changed area from the DB in step 407. When a digital broadcast service is determined in step 407, the broadcast receiver searches for a digital channel in step 409. In addition, when an analog broadcast service is determined in step 407, the broadcast receiver searches for an analog channel in step 411. Furthermore, when both an analog and a digital broadcast service is determined in step 407, the broadcast receiver searches for a digital channel in step 413 and searches for an analog channel in step 415.

The broadcast receiver generates a list of searched channels and stores the same in the DB in step 417.

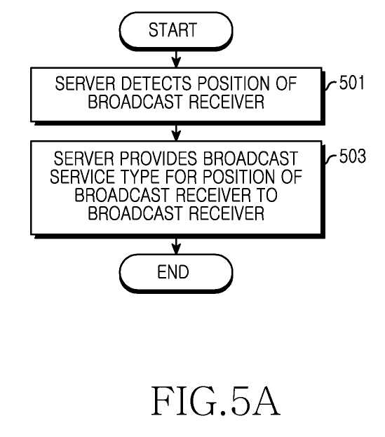

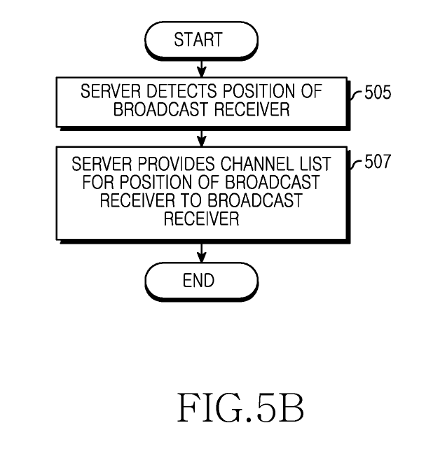

FIGS. 5A and 5B represent flowcharts illustrating a procedure for providing broadcast information at a network server to an analog/digital broadcast receiver according to an exemplary embodiment of the present invention. A broadcast receiver according to an exemplary embodiment of FIG. 5A may receive broadcast information (for example: a broadcast service type, a channel list, etc.) from a network server and preforms an appropriate broadcast. The network server determines the position of the broadcast receiver and derives broadcast information corresponding to the determined position from information in the DB to provide the same to the broadcast receiver. The server may receive this broadcast information from a broadcasting company of each area and to update the broadcast information accordingly. Referring to FIG. 5A, the server determines a position of a broadcast receiver in step 501. The server may receive information that the broadcast receiver has received from a GPS satellite to determine the position. In addition, in the case where the broadcast receiver is a cellular phone, the cellular phone may determine the position via a service cell ID of a base station and the server may determine the position.

Next, the server determines the position of the broadcast receiver and provides a broadcast service type to the broadcast receiver in step 503. The server determines a broadcast area to which the position belongs and determines a broadcast service type provided in the determined broadcast area from a DB. The server determines a broadcast service type from a broadcast service company of each area and updates the DB using this information.

After that, the broadcast receiver that has received the broadcast service type from the server may perform processes subsequent to step 309 of FIG. 3, or processes subsequent to step 407 of FIG. 4.

Referring to FIG. 5B, the server determines a position of a broadcast receiver in step 505. The server may receive information that the broadcast receiver has received from a GPS satellite to determine the position. In addition, in the case where the broadcast receiver is a cellular phone, the cellular phone may determine the position via a service cell ID of a base station and the server may determine the position.

Next, the server provides a broadcast channel list corresponding to the position of the broadcast receiver to the broadcast receiver in step 507. The server may determine a broadcast area to which the position belongs and determine a channel list provided in this determined broadcast area from a prepared DB. The server determines a channel list of each broadcast area from a broadcast service company and updates the DB using this information accordingly.

After that, the broadcast receiver that has received the channel list from the server completes broadcasting preparation. That is, the broadcast receiver that has received the channel list from the server does not need to search for a channel separately.

Consequently, a method and an apparatus for scanning a channel in a broadcast receiver according to an exemplary embodiment of the present invention may efficiently search for a channel while moving to another broadcasting area.

The above-described methods according to the present invention can be implemented in hardware, firmware or as software or computer code that can be stored in a recording medium such as a CD ROM, an RAM, a floppy disk, a hard disk, or a magneto-optical disk or computer code downloaded over a network originally stored on a remote recording medium or a non-transitory machine readable medium and to be stored on a local recording medium, so that the methods described herein can be rendered in such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein.

Although the invention has been shown and described with reference to certain exemplary embodiments thereof, it will be understood by those skilled in the art that various changes in form and details may be made therein without departing from the spirit and scope of the invention as defined by the appended claims and their equivalents. Therefore, the scope of the present invention should not be limited to the above-described embodiments but should be determined by not only the appended claims but also the equivalents thereof.

What is claimed is:

1. A method for determining a broadcast channel in a broadcast receiver, the method comprising:
determining a current position,
deriving a broadcast area corresponding to the current position from a database (DB);
determining whether a valid channel list for the derived broadcast area exists in the DB; and
when the valid channel list for the derived broadcast area does not exist, initiating a process to search for a channel for the derived broadcast area.

2. The method of claim 1, where the searching for a channel for the derived broadcast area comprises;
searching for only a digital channel when the derived broadcast service type is a digital broadcast service,
searching for only an analog channel when the derived broadcast service type is an analog broadcast service, and
searching for a digital channel and then searching for an analog channel when the derived broadcast service type includes both an analog and a digital broadcast service.

3. The method of claim 1, wherein the determining of the current position uses a Global Positioning System (GPS).

4. The method of claim 1, wherein the broadcast receiver determines the current position through one of: a service cell identifier (ID) of a base station, and receiving position information from a network server.

5. The method of claim 2, wherein searched channels are generated as a list and stored for a corresponding broadcast area.

6. The method of claim 1, wherein the valid channel list does not exceed a threshold time after a channel list for a relevant broadcast area is generated.

7. A method for scanning a channel in a broadcast receiver, the method comprising:
extracting a transmission type and a channel list associated with a broadcast area, said broadcast area being associated with a position of the broadcast receiver;
determining whether the position of the broadcast receiver changes sufficiently such that the broadcast area changes;
determining whether the transmission type and channel list are applicable to the changed broadcast area and
when one of the transmission type and channel list is not applicable to the changed broadcast area, initiating a process to search for a channel for the changed broadcast area.

8. The method of claim 7, further comprising:
searching for only a digital channel when the derived broadcast service type is a digital broadcast service,
searching for only an analog channel when the derived broadcast service type is an analog broadcast service, and
searching for a digital channel and then searching for an analog channel when the derived broadcast service type is both an analog and a digital broadcast service.

9. The method of claim 7, wherein the determining whether the broadcast area changes comprise:
determining a current position; and
determining that the broadcast area has changed when the determined current position is not included in an existing broadcast area.

10. The method of claim 7, wherein initiating a process to search for the channel for the changed broadcast area is performed when the channel list for the changed broadcast area in a DB is determined not to be valid.

11. The method of claim 7, further comprising:
stopping the broadcasting, searching for a channel for the changed broadcast area to configure a new channel list, and preparing broadcasting using this new channel list when valid channel list for the changed broadcast area is not valid; and
stopping the broadcasting and preparing broadcasting using the valid channel list for the changed broadcast area when the valid channel list for the changed broadcast area exists.

12. The method of claim 7, further comprising, when channel search starts, broadcasting is not performed using a channel list of an existing broadcast area, and a valid channel list for the changed broadcast area does not exist, searching for a channel for the changed broadcast area to configure a list as a background operation; and
preparing broadcasting using this list afterward.

13. The method of claim 9, wherein the determining of the current position uses a Global Positioning System (GPS).

14. The method of claim 9, wherein the current position is determined by one of: a service cell identifier (ID) of a base station, and receiving position information from a network server.

15. The method of claim 7, wherein searched channels are generated as a list and stored for each broadcast area.

16. The method of claim 10, wherein the valid channel list does not exceed a threshold time after a channel list for a relevant broadcast area is generated.

17. An apparatus for scanning a channel in a broadcast receiver, the apparatus comprising:
a memory for storing broadcast information;
a position information unit for outputting position information;
a scan setting unit for deriving a relevant broadcast area from the memory based on the position information output from the position information unit, and initiating a process to start a channel search for the derived broadcast area when a valid channel list for the derived broadcast area does not exist in the memory; and
a synchronizer for searching for a channel under control of the scan setting unit.

18. The apparatus of claim 17, wherein the position information unit outputs the position information using a Global Positioning System (GPS).

19. The apparatus of claim 17, wherein the position information is obtained from one of: a service cell identifier (ID) of a base station and a network server.

20. The apparatus of claim 17, wherein the valid channel list does not exceed a threshold time after a channel list for a relevant broadcast area is generated.

21. An apparatus for scanning a channel in a broadcast receiver, the apparatus comprising:
a memory for storing broadcast information;
a position information unit for outputting position information;
a scan setting unit for determining a current position from the position information output from the position information unit, and starting a channel search for a changed broadcast area when the current position deviates from an existing broadcast area; and
a synchronizer for searching for a channel under control of the scan setting unit.

22. The apparatus of claim 21, wherein when a valid channel list for the changed broadcast area is determined not to be in the memory, the scan setting unit initiates a channel search for the changed broadcast area.

23. The apparatus of claim 21, wherein the position information unit outputs the position information using a Global Positioning System (GPS).

24. The apparatus of claim 21, wherein the position information is obtained from one of: a service cell identifier (ID) of a base station and a network server.

25. The apparatus of claim 22, wherein the valid channel list does not exceed a threshold time after a channel list for a relevant broadcast area is generated.

26. A method for initiating a channel search of a broadcast receiver in a network server, the method comprising:
detecting a position of the broadcast receiver;
deriving a broadcast area to which the detected position belongs from a database (DB);
deriving broadcast information regarding the derived broadcast area from the DB; and
transmitting the derived broadcast information to the broadcast receiver.

27. The method of claim 26, wherein the broadcast information comprises a broadcast type comprising an analog broadcast service, a digital broadcast service, and both an analog broadcast service and a digital broadcast service, or a channel list.
